(19) United States
(12) Patent Application Publication
(10) Pub. No.: US 2024/0276967 A1
(43) Pub. Date: Aug. 22, 2024

(54) ARTHROPOD TRAPPING DEVICE

(71) Applicant: The Procter & Gamble Company, Cincinnati, OH (US)

(72) Inventors: Christopher Lawrence SMITH, Liberty Township, OH (US); Adam James BURT, Cincinnati, OH (US); Erik John HASENOEHRL, Loveland, OH (US); Keven James WALTER, Cincinnati, OH (US); Andrea PEDROTTI, Cavedine Trento (IT); Walter SORDO, Trento (IT); Alessio GIOVANELLI, Trento (IT); Thomas Bernard WALKER, III, Cincinnati, OH (US)

(21) Appl. No.: 18/438,980

(22) Filed: Feb. 12, 2024

Related U.S. Application Data
(60) Provisional application No. 63/446,797, filed on Feb. 17, 2023.

(51) Int. Cl. A01M 1/14

(52) U.S. Cl. CPC A01M 1/145; A01M 2200/012

(57) ABSTRACT

The present disclosure relates generally to an arthropod trapping device, more particularly, to a compact and portable trapping device comprising a housing and an insert.

### FIELD OF THE INVENTION

The present disclosure relates generally to an arthropod trapping device, more particularly, to a compact and portable trapping device comprising a housing and an insert.

### BACKGROUND OF THE INVENTION

Historically, a variety of arthropod control devices have been employed to trap arthropods, particularly insects. Such devices typically employ an attraction mechanism for luring arthropods to the device. Example attraction mechanisms include baits such as food, light, heat, pheromones, or other odorous materials found attractive by the arthropod. Some arthropod control devices have historically included an immobilization mechanism to prevent the arthropods from exiting the device. One type of immobilization mechanism used is a substrate such as a board, a paper, or other medium having a surface coated with an adhesive. Arthropods attracted to the device or incidentally coming into contact with the adhesive become trapped by adhesion.

Arthropod trapping devices that combine an adhesive for trapping insects together with light are known. Arthropod traps having a large fluorescent tube that emits light, for example, UV light, visible light, or both, to attract insects and a glue board to trap them are known. Such traps may be effective at trapping arthropods, but the light emitted by such traps may be too bright for some consumers. Such traps may also be too large to fit in small spaces, too noticeable for some spaces inside the home, such as a kitchen or a bathroom, and too expensive to afford one for every room in the house. Furthermore, the glue boards in these traps may be difficult to remove and replace without touching trapped insects and adhesive. Smaller, disposable arthropod traps that comprise LED lights and an adhesive, have a minimal footprint, and have an aesthetically pleasing design are also known. However, such traps may not be as effective at capturing arthropods as, for example, larger traps having fluorescent tubes.

There is a need for an arthropod trapping device that is effective at capturing arthropods, is not offensively bright, and has a compact, aesthetically pleasing design. There is also a need for a trap that can be maintained and handled without contacting trapped insects or insect debris. The present disclosure meets these needs by providing a device that comprises a housing, which comprises a base and a shade coupled to the base, where the base comprises a light source (e.g., LED) and where the shade is configured to receive an insert that comprises an at least partially reflective, concave, light source-facing surface with an adhesive disposed thereon.

### SUMMARY OF THE INVENTION

The present disclosure relates to an arthropod trapping device comprising: a housing comprising a base and a shade coupled to the base, the base and the shade defining an opening in the housing: a. the base configured to communicate with and receive power from a power source, wherein at least one LED is mounted on the base; b. the shade configured to receive more than one insert, wherein the shade comprises a front wall, a rear wall, and first and second side walls located between the front wall and the rear wall, wherein at least one of the side walls, preferably both side walls, comprise(s) an opening, preferably a vertical opening.

### BRIEF DESCRIPTION OF THE DRAWINGS

FIG. 1 is a front, right-side isometric view of an example arthropod trapping device, without a cord and plug, in accordance with the present disclosure;

FIG. 2 is a top view of the arthropod trapping device of FIG. 1;

FIG. 3 is a bottom view of the arthropod trapping device of FIG. 1;

FIG. 4 is a front view of the arthropod trapping device of FIG. 1;

FIG. 5 is a right side view of the arthropod trapping device of FIG. 1;

FIG. 6 is a rear view of the arthropod trapping device of FIG. 1;

FIG. 7 is a left side view of the arthropod trapping device of FIG. 1;

FIG. 8 is a rear, left-side isometric view of an example insert for an arthropod trapping device in accordance with the present disclosure;

FIG. 9 is a front, right-side isometric view of the insert shown in FIG. 8;

FIG. 10 is a right-side view of the insert shown in FIG. 8;

FIG. 11 is a left-side view of the insert shown in FIG. 8;

FIG. 12 is a rear view of the insert shown in FIG. 8;

FIG. 13 is a top view of the insert shown in FIG. 8;

FIG. 14 is a bottom view of the insert shown in FIG. 8;

FIG. 15 is a front, left-side isometric view of an example housing for an arthropod trapping device in accordance with the present disclosure;

FIG. 16 depicts two of the inserts shown in FIG. 8 being inserted into the housing shown in FIG. 15.

FIG. 17 depicts a left side view of the arthropod trapping device of FIG. 16, with the inserts inserted into the housing.

FIG. 18 is a cross-sectional view along plane 18-18 of FIG. 17.

FIGS. 19a and 19b are bottom, right side isometric views of an example arthropod trapping device, with a cord and plug, in accordance with the present disclosure. In FIG. 19b, the bottom plate of the device, which is shown in FIG. 19a, is removed to display the storage of the cord.

FIG. 20 is a front, right-side isometric view of the housing of the arthropod trapping device shown in FIG. 1, where the housing is bisected by a plane that extends through vertical centerline 1-1 and vertical centerline 2-2 and a plane that extends through vertical centerline 3-3 and vertical centerline 4-4.

### DETAILED DESCRIPTION OF THE INVENTION

To provide an overall understanding of the devices and methods described herein, certain illustrative embodiments will now be described. For the purpose of clarity and illustration, these devices and methods will be described with respect to arthropod trapping devices used for indoor residential or commercial purposes.

It will be understood by one of ordinary skill in the art that the devices and methods described herein may be adapted and modified as appropriate. The terms “arthropod trapping device,” “device,” “trapping device,” and “trap” are used interchangeably. Arthropods include insects, such as flies, mosquitos, ants, dragonflies, and bees, arachnids, such as spiders, and myriapods, such as centipedes and millipedes.

The present disclosure provides for arthropod trapping devices, methods of making arthropod trapping devices, and methods of using arthropod trapping devices. Various nonlimiting embodiments of the present disclosure will now be described to provide an overall understanding of the principles of the function, design and use of the arthropod trapping devices disclosed herein. One or more examples of these nonlimiting embodiments are illustrated in the accompanying drawings. Those of ordinary skill in the art will understand that the methods described herein and illustrated in the accompanying drawings are nonlimiting examples and that the scope of the various nonlimiting examples of the present disclosure are defined solely by the claims. The features illustrated or described in connection with one nonlimiting example can be combined with the features of other nonlimiting examples. Such modifications and variations are intended to be included within the scope of the present disclosure.

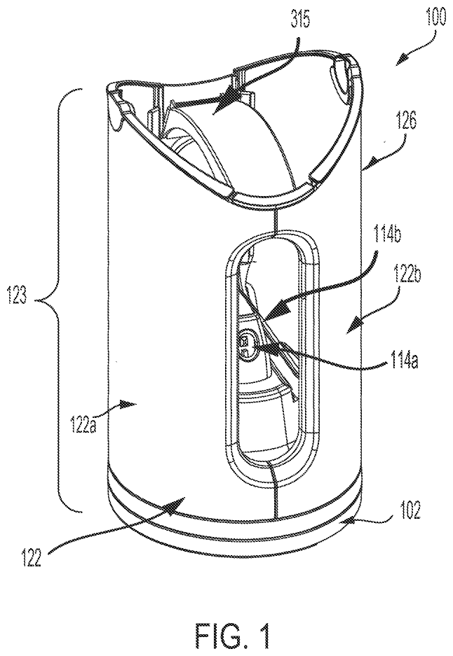

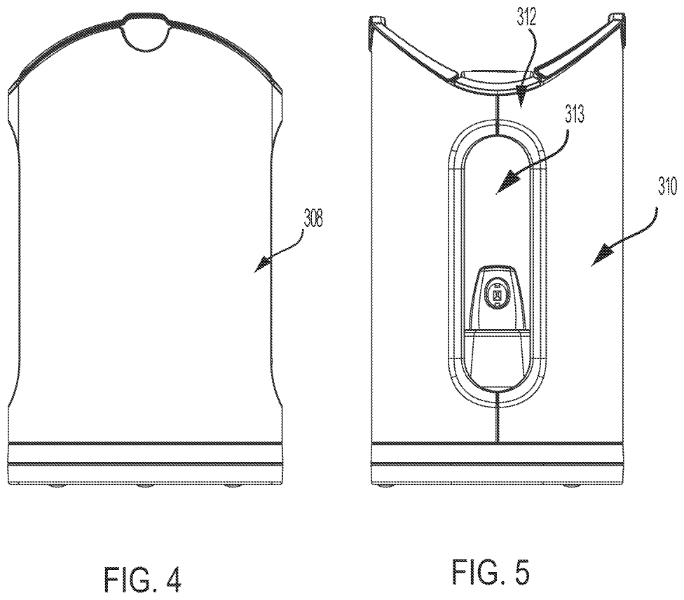

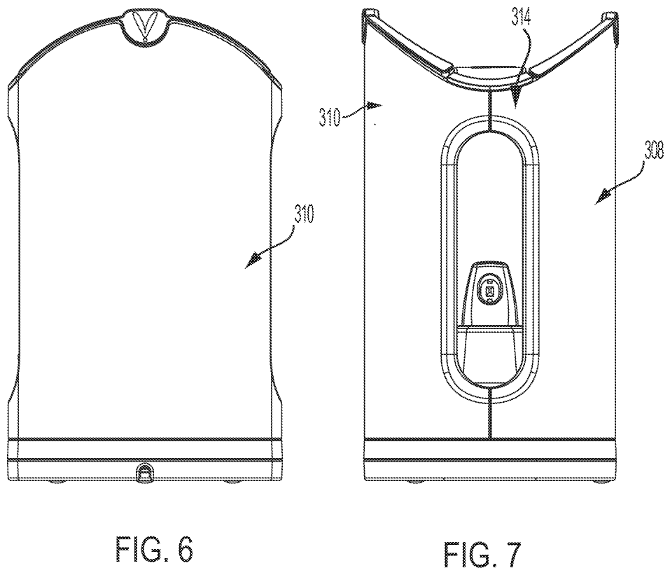

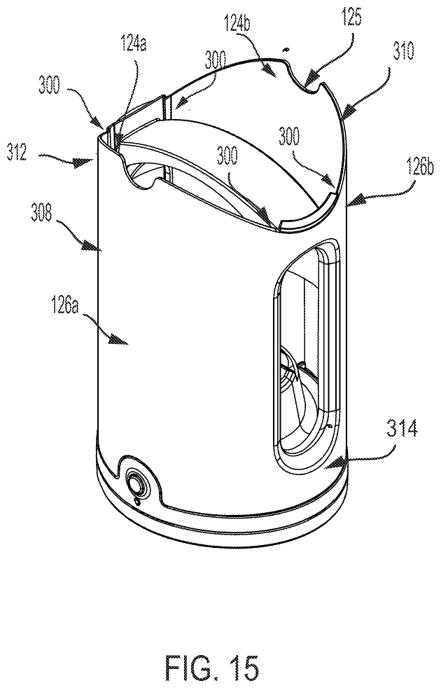

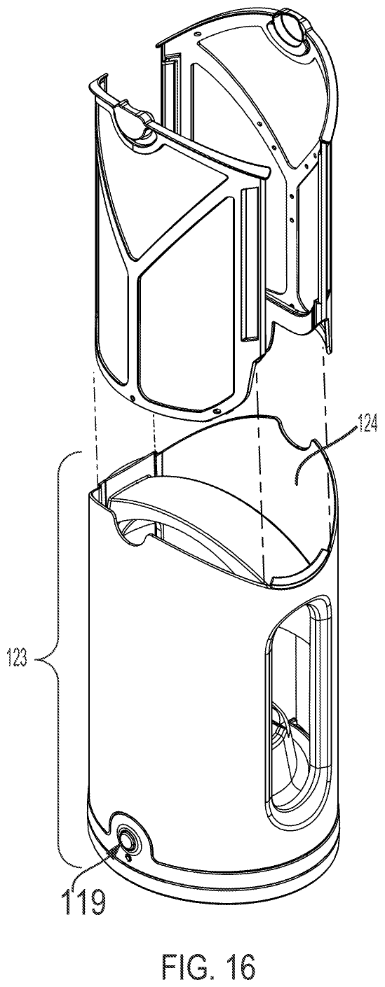

Referring now to FIGS. 1-7, an example arthropod trapping device 100 in accordance with a non-limiting embodiment is depicted. The arthropod trapping device 100 may have a housing 123 comprising a base 102 and a shade 122 coupled to the base 102. The shade 122 may be constructed of separate pieces, such as the two pieces (122a, 122b). Alternatively, the shade 122 may have a unitary construction. The shade 122 and the base 102 can be separate pieces that are coupled together to form the housing 123, or the shade 122 and the base 102 may integrally form the housing 123 and the housing 123 may have a unitary construction. The housing 123 may be configured to receive an insert 150. The housing may be configured to receive more than one insert 150, preferably two or more inserts 150. FIG. 16 depicts two inserts 150 being inserted into the housing 123. The insert(s) 150 may be mechanically engaged with the housing 123 when the insert(s) 150 are seated within the housing 123, such as through interlocking features or a friction-fit, for instance. More specifically, the shade may comprise at least one guiderail 300, preferably a least one pair of guiderails 300, more preferably at least two pairs of guiderails 300, as shown in FIG. 15.

The guiderails 300 may aid in aligning and securing the one or more insert(s) 150, as shown in FIG. 16. The guiderails 300 may help the user engage the insert(s) 150 with the housing 123 and allow for insertion at various orientations or angles. In other words, the user need not have the insert(s) precisely aligned with the trap housing in order to properly and/or securely place the insert(s) into the housing. The guiderail(s) may have a flared opening (not shown) at one end, where the flared opening is wider and/or deeper than the rest of the guiderail. The flared opening may facilitate the placing or positioning of the insert into the guiderail(s). The length of the flared opening may be about 1% to about 25% or about 5% to about 20% of the length of the entire guiderail. The guiderails may be about 40 mm to about 150 mm in length, or about 50 mm to about 125 mm in length, or about 60 mm to about 100 mm in length. The guiderails may be about 80 mm in length. The width and/or depth of the guiderail may further vary over the length of the guiderail, for example, the guiderail may have a reduced width and/or depth at one end, such as the end opposite a flared opening, if present, to facilitate a friction fit between the insert and the housing.

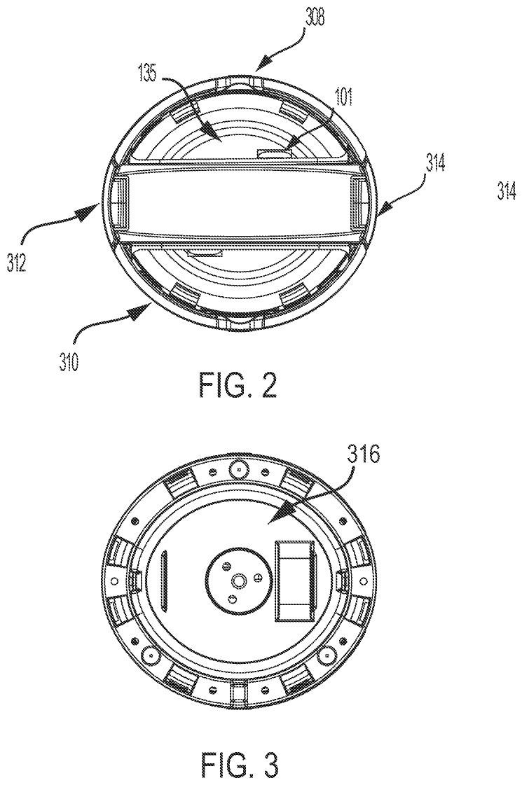

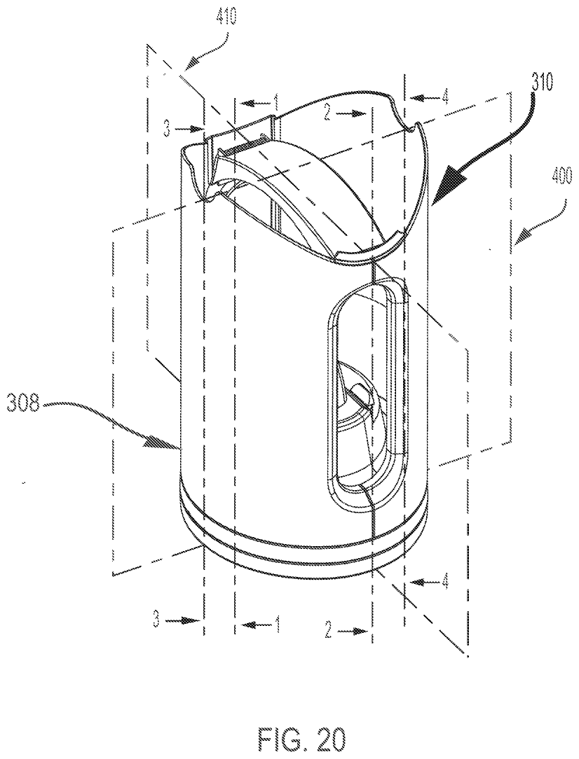

The shade 122 may comprise a front wall 308, a rear wall 310, and opposing side walls 312, 314. Each side wall may be located between the front wall and the rear wall, as shown in FIGS. 3-7. The front wall 308, the rear wall 310, and the opposing side walls 312, 314 may be continuous. The front wall 308, the rear wall 310, and the opposing side walls 312, 314 may be discontinuous or segmented, for example, where one or more of or a portion of one or more of the front wall 308, the rear wall 310, and the opposing side walls 312, 314 form separate pieces that are connected to one another. The shade 122 may be substantially cylindrical in shape and comprise a continuous or discontinuous wall. The shade may be substantially cylindrical in shape and may comprise a front wall 308, a rear wall 310, and opposing side walls 312, 314, each of which is substantially curvilinear, as shown in FIGS. 1-7. The shade may comprise a curvilinear wall that is substantially free of angular, sharp, non-radiused, or non-rounded edges and is continuous. The shade 122 may be substantially cylindrical in shape and comprise a discontinuous wall and one or more angular or non-rounded edges, for example, the shade may have a polygonal (e.g., hexagonal, octagonal) prism shape (not shown). The shade 122 may be substantially cylindrical in shape and have an elliptical cross section—an elliptic or oval cylinder. Altogether, it will be appreciated that the shade can be provided in various shapes and sizes without departing from the scope of the present disclosure. For example, the shade 122 can be provided with one or more walls which are more curvilinear or less curvilinear in shape than illustrated in FIGS. 1-7. As shown in FIGS. 1 and 15, the shade may have an outward-facing surface 126 and insert-facing surface 124. As shown in FIGS. 2 and 15, the shade may comprise a front wall 308, a rear wall 310, and opposing side walls 312, 314, where the insert-facing surface 124a of the front wall 308 and the insert-facing surface 124b of the rear wall 310 are concave, while the outward-facing surface 126a of the front wall 308 and the outward-facing surface 126b of the rear wall 308 are convex. At least one of the opposing side walls 312, 314, preferably both side walls 312, 314, may comprise(s) an opening 313, preferably a vertical opening 313 that extends from about 30% to about 100% of the length of the side wall(s) 312, 314. The vertical opening 313 may be symmetric across a vertical centerline 1-1 and/or a vertical centerline 2-2, as shown in FIG. 20.

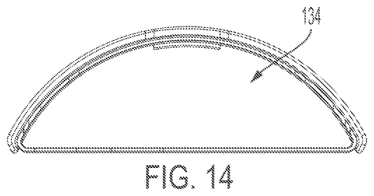

The insert 150 may comprise a graspable tab 168 located at a second end 138 of the insert 150. The insert 150 may comprise a mounting bracket 120 spaced apart from the light source-facing surface 130 of the insert 150 and located at a first end 136 of the insert 150, such that the light source-facing surface 130 of the insert 150 and the bracket 120 collectively define an opening 134 in the insert 150 (see FIG. 14). The first end 136 of the insert 150 is the end proximate to the base 102 (when the insert 150 is inserted into the housing 123, as it would be during use). The opposing sides of the opening 134 may be tapered, grooved, or otherwise configured to aid in proper alignment of the insert 150 as it is slid into the housing 123 by a user. Preferably, the surface of the shade 122 and the surface of the insert 150 are devoid of openings that are large enough to allow arthropods to enter through the openings into the trap.

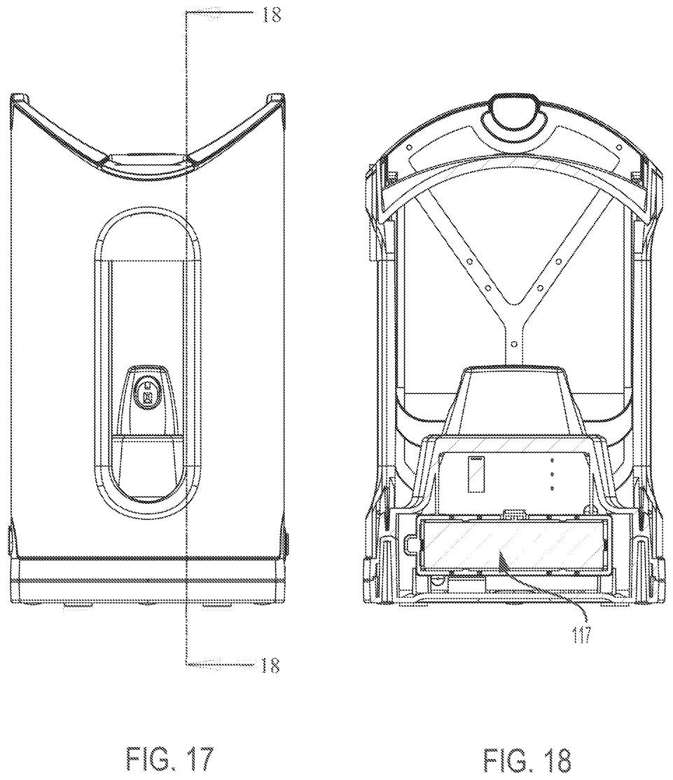

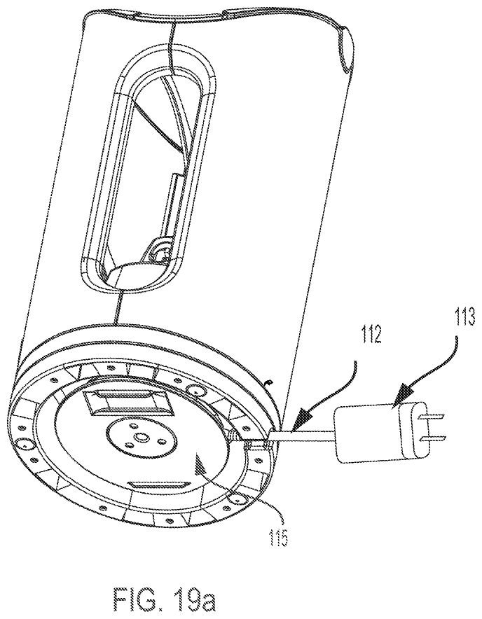

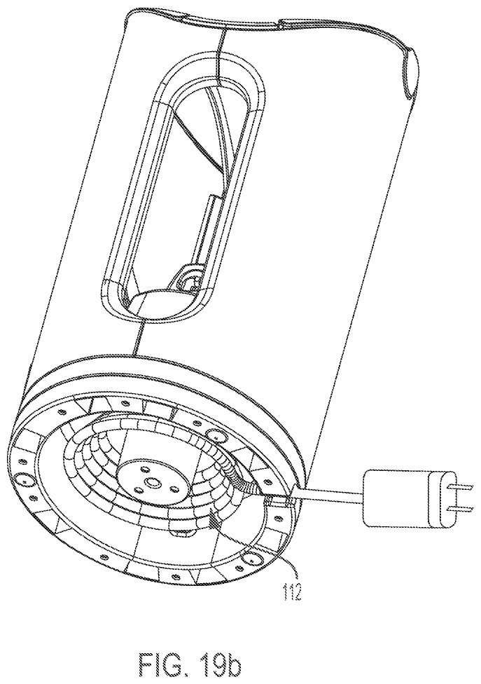

The base 102 and the shade 122 may define an opening 135 in the housing 123 (as shown in FIG. 2). Arthropods may enter the device 100 through the opening 135 in the housing 123. Light may escape through the opening 135 in the housing 123 and attract arthropods to the trap. 4. The arthropod trapping device may further comprise a bridge 315 that extends over the opening 135 of the housing and joins the first side wall 312 to the second side wall 314, preferably joining the inner surfaces 124c, 124d of the first and second side walls 312, 314. The base 102 may include a cord 112 that has two ends-a first end connecting to the arthropod trapping device 100 and a second end that may be plugged into a suitable power source, such as a wall socket. The second end, which may be plugged into a suitable power source, may comprise a plug 113 comprising one or more electrically conductive prongs, e.g., a 3-prong electrical plug or a USB plug. FIGS. 19a and 19b show an example arthropod trapping device, in accordance with the present disclosure, which has a cord and plug. In FIG. 19b, the bottom plate 115 of the device, which is shown in FIG. 19a, is removed to display the storage of the cord 112. In other configurations, such as the one shown in FIGS. 16-19, the arthropod trapping device 100 can draw power from an onboard battery 117. The arthropod trapping device can also draw power from other types of power sources, such as solar power. The arthropod trapping device may optionally have a power button 119, as shown in FIGS. 16-19).

The arthropod trapping device 100 can utilize a variety of attractants to draw insects into the device, such as heat, light, chemical attractants, and so forth, some of which may require a power source to operate. As such, the power source may be used to energize various onboard components, such as an electric heating element (not shown), a light source 114, such as an LED, and/or other components which may serve to attract insects to the arthropod trapping device 100. Examples of suitable chemical attractants include water, water vapor, sugar, sugar solution, molasses, honey, yeast, insect-attracting scents, pheromones, and combinations thereof. Further examples of chemical attractants include sorbitol, coleopteran attractants including brevicomin, dominicalure, frontalin, grandlure, ipsdienol, ipsenol, japonilure, lineatin, megatomoic acid, multistriatin, oryctalure, sulcatol, and trunc-call, dipteran attractants including ceralure, cue-lure, latilure, medlure, moguchun, muscalure, and trimedlure, homopteran attractants including rescalure, lepidopteran attractants such as disparlure, straight chain lepidopteran pheromones including codlelure, gossyplure, hexalure, litlure, looplure, orfralure, and ostramone, organic acids including lactic acid and malic acid, and other insect attractants such as eugenol, methyl eugenol, and siglure, or other substances to provide a scent that further increases the insect-attracting efficiency of insect trap. The chemical attractant may be a fruit or piece of fruit such as a banana. Alternatively, a combination of live yeast, sugar, and water, which can produce mosquito-attracting carbon dioxide may be used.

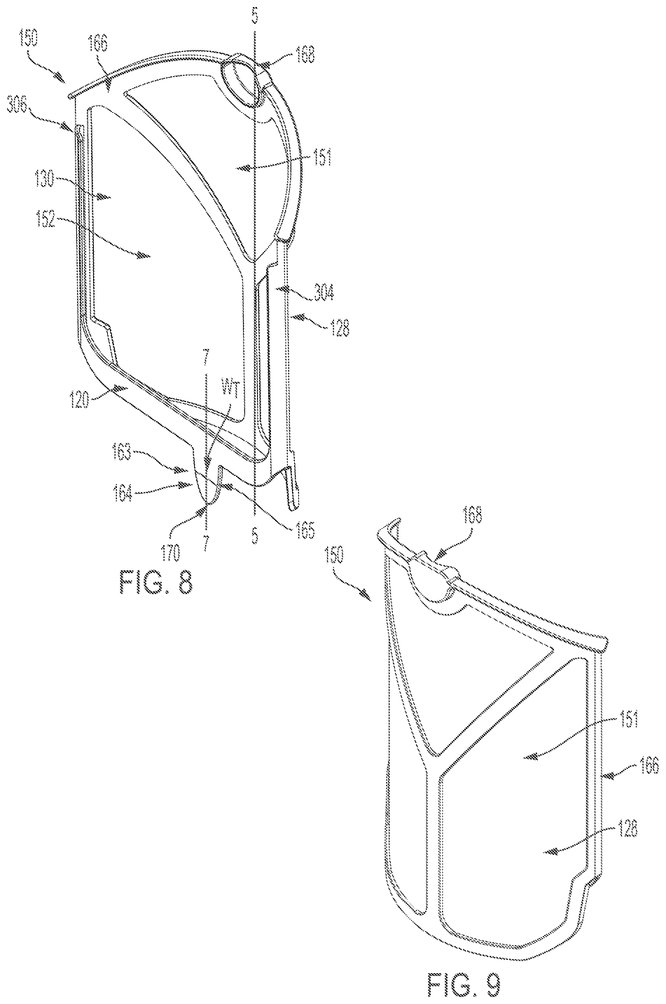

As shown in FIG. 1, the shade 122 may have an outward-facing surface 126 and an insert-facing surface 124, which may be configured to receive an insert 150, as shown in FIG. 8, which comprises a shade-facing surface 128 and a light source-facing surface 130, where an adhesive 152 for immobilizing an arthropod is disposed on the light source-facing surface 130 of the insert 150. The shade 122 may include one or more pairs of opposing guiderails 300 extending at least partially along the insert-facing surface 124a, 124b of the shade 122, as shown in FIG. 15. The guiderails may be integral to the shade. The guiderails may (at least partially) form the perimeter of the vertical opening on the insert-facing surface(s) 124a, 124b or the inner surface of the shade. The guiderails 300 may maintain the relative placement of an insert 150 via friction fit, for example, when an insert 150 is slid into the shade 122. Other techniques may be used to mechanically engage the insert 150 with the shade 122.

The shade 122 and/or insert may be opaque. The shade 122 and/or insert may have regions that are opaque. The opacity of the shade and the insert may be measured according to ASTM D1746-15. The shade may have a regular transmittance (Tᵣ) of less than about 10%, or less than about 5%, or less than about 2%, or less than about 1%, or less than about 0.5%. The insert may have a regular transmittance (Tᵣ) of less than about 90%, or less than about 75%, or less than about 50%, or less than about 30%, or less than about 20%, or less than about 10%, or less than about 5%, or less than about 2%, or less than about 1%, or less than about 0.5%. The shade or insert may have a greater regular transmittance (Tᵣ) in one region than in another region. The shade or insert may have a color(s). The shade and/or insert may conceal trapped arthropods and debris. During use, the opacity of the shade and/or insert may also reduce how bright the trap appears, as compared to the rest of the room where the trap is being used.

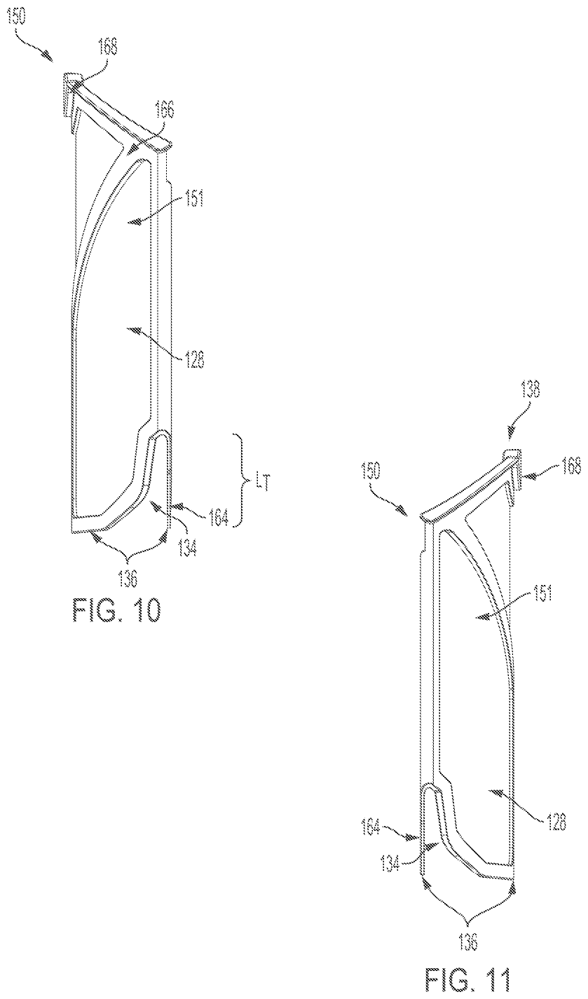

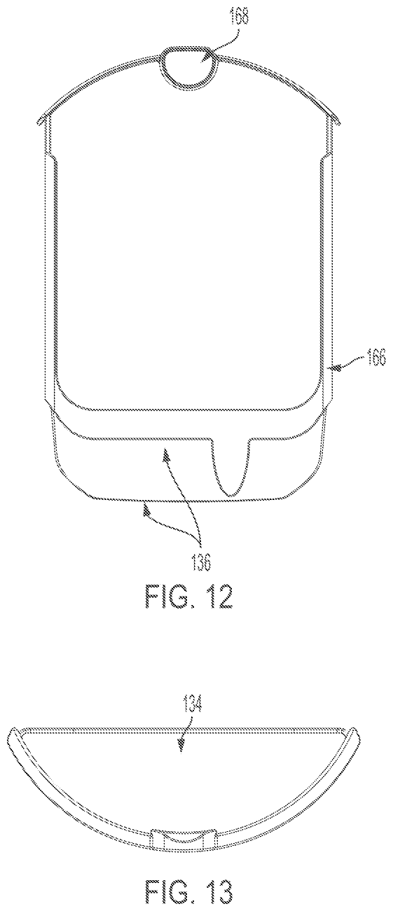

FIGS. 8-14 shown an insert 150. As described in more detail below, an adhesive 152, which immobilizes arthropods that contact it, may be disposed on a surface of the insert 150. The insert 150 may comprise a frame 166 and a substrate 151 attached to or otherwise formed with the frame 166. The adhesive 152 for immobilizing the arthropod may be disposed on a surface of the substrate 151, preferably on the light source-facing surface 130 of the insert. The adhesive 152 immobilizes arthropods that land on the light source-facing surface 130 of the insert and contact the adhesive 152. The adhesive 152 may be coated on or otherwise applied to or incorporated in or on the substrate 151. The adhesive 152 may be disposed on both the shade-facing surface 128 and the light source-facing surface 130 of the insert 150. In such configurations, there is preferably a space between the shade-facing surface 128 of the insert 150 and the insert-facing surface 124 of the shade 122, and arthropods may land on the shade-facing surface 128 of the insert 150, the light source-facing surface 130 of the insert 150, or both. The insert may comprise at least one flange 304 configured to slide into the at least one guiderail 300 of the shade 122. The at least one flange may be wider at one end 306, where the wider end of the flange 306 may be aligned with a flared opening of the guiderail, if present, when the insert is inserted into the shade.

The adhesive 152 may be selected from the group consisting of an acrylic polymer adhesive, a butyl rubber adhesive, a natural rubber adhesive, a nitrile adhesive, a silicone adhesive, a styrene block copolymer adhesive, a styrene-ethylene/propylene adhesive, a styrene-isoprene-styrene adhesive, a vinyl ether adhesive, and mixtures thereof. The adhesive may optionally be a pressure sensitive adhesive. The substrate 151 may be provided in a wide variety of forms, such as a film, a woven or a non-woven (including papers). The substrate 151 may be in the form of a film comprising one or more polymers, such as polycarbonate, polyethylene terephthalate (PET) or polypropylene. The substrate 151 may comprise one or more layers. Generally, the thickness of the substrate 151 (with or without adhesive 152 disposed thereon) may be in the range of about 0.01 mm to about 5 mm. The thickness of the substrate 151 (with or without adhesive 152 disposed thereon) may be in the range of about 0.05 mm to about 1.0 mm. The adhesive surface area (area of the surface of the device or insert that has adhesive 152 disposed thereon, see, for example, FIG. 30) may be from about 25 cm² to about 200 cm², or from about 50 cm² to about 175 cm², or from about 75 cm² to about 150 cm², or from about 100 cm² to about 145 cm².

The adhesive 152 may be opaque, transparent, or translucent. The substrate 151 may be opaque, transparent, or translucent. The substrate 151 (with or without adhesive disposed thereon) may have a regular transmittance (Tᵣ) of less than about 90%, or less than about 75%, or less than about 50%, or less than about 30%, or less than about 20%, or less than about 10%, or less than about 5%, or less than about 2%, or less than about 1%, or less than about 0.5%. Preferably, both the adhesive 152 and the substrate 151 are transparent or translucent. The substrate 151 with the adhesive 152 disposed thereon may have a regular transmittance (Tᵣ) of greater than about 50%, or greater than about 75%, or greater than about 85%, or greater than about 90%, or greater than about 92.5%, or greater than about 95%, or greater than about 97.5%, or greater than about 99%, or greater than about 99.5%. More specifically, the substrate 151 may transmit greater than about 50%, or greater than about 60%, or greater than about 70%, or greater than about 80% of UV light. The substrate 151 may transmit greater than about 50%, or greater than about 70%, or greater than about 90% of blue light. The adhesive 152 may transmit less than about 60%, or less than about 50%, or less than about 40% of UV light. The adhesive 152 may transmit greater than about 50%, or greater than about 70%, or greater than about 90% of blue light. The substrate 151 with the adhesive 152 disposed thereon may transmit less than about 50%, or less than about 40%, or less than about 30% of UV light. The substrate 151 with the adhesive 152 disposed thereon may transmit greater than about 50%, or greater than about 70%, or greater than about 90% of blue light.

A transparent or translucent substrate 151 having a transparent or translucent adhesive 152 disposed thereon allows for captured arthropods to be viewed through the substrate, without fully removing the insert 150 from the housing 123 and/or without directly examining the adhesive surface of the insert. Thus, a user need not fully remove insert from the housing and rotate the insert in order to view the captured arthropods and/or determine if the insert should be disposed of and replaced with a new insert. A releasable liner (not shown) may be applied to the adhesive 152 to cover and protect the adhesive 152 prior to use. A user may peel away the releasable liner to expose the adhesive 152 immediately prior to inserting the insert 150 into the shade 122.

While the insert 150 is shown to include a frame 166 that surrounds the entire perimeter of the insert 150, this disclosure is not so limited. For instance, the frame 166 may only extend partially around the perimeter of the insert 150. The frame 166 may, for example, extend along all but the first end 136 of the insert 150. In other configurations, the insert 150 can be frameless, with the adhesive portion 152 applied to at least a central portion of the substrate 151, with the substrate 151 providing sufficient structural rigidity. Further, the insert 150 and/or the substrate 151 may be concave-convex (where one surface of the substrate is concave and the opposing surface of the substrate is convex) or have other suitable configurations, such as planar or pleated, for instance. Opposing edges of the frame 166 may be connected, for example as shown in FIGS. 8-14, to provide additional structural support and rigidity to the insert 150.

Also as shown in FIGS. 8-14, the insert 150 may comprise a downwardly depending tab 164. The downwardly depending tab 164 may be positioned on the first end 136 of the insert 150. The downwardly depending tab 164 may extend downwardly from the mounting bracket 120. As described above, the mounting bracket 120 may be spaced apart from the light source-facing surface 130 of the insert 150, such that the light source-facing surface 130 of the insert 150 and the bracket 120 collectively define an opening 134 in the insert 150. The maximum distance between the light source-facing surface 130 of the insert 150 and the bracket 120, measured at a vertical centerline 5-5 of the insert 150, may be from about 5 mm to about 50 mm, or from about 10 mm to about 40 mm, or from about 10 mm to about 35 mm.

The downwardly depending tab 164 can be positioned such that a vertical centerline 7-7 of the downwardly depending tab 164 is horizontally offset from the vertical centerline 5-5 of the insert 150, as shown in FIG. 8. Horizontally offsetting the downwardly depending tab 164 may serve to aid in properly aligning the insert 150 with the base 102 of the device. As shown, due to the tab 164 being horizontally offset, the vertical centerline 5-5 of the insert does not overlap any portion of the tab 164. In this regard, the first side edge 163 and the second side edge 165 of the tab 164 are each horizontally offset from the vertical centerline 5-5 of the insert 150. The second side edge 165 may be horizontally offset from the vertical centerline 5-5 further than the first side edge 163. Furthermore, since the first side edge 163 and the second side edge 165 are offset in the same horizontal direction, both the first side edge 163 and the second side edge 165 of the tab 164 may be positioned on the same horizontal side of the insert 150. The vertical centerline 7-7 of downwardly depending tab 164 may be horizontally offset from the vertical centerline 5-5 of the insert 150 by about 5 mm to about 25 mm, or from about 8 mm to about 20 mm, or from about 10 mm to about 15 mm.

The base 102 of the device may receive the downwardly depending tab 164 of each insert, when each insert 150 is inserted into the housing 123. The base may comprise a switch (not shown), which may function to operate one or more of the insect attractants (e.g., a light source 114, etc.), so that such insect attractants can only be energized when one or more of the inserts 150 is engaged with the base 102. As such, when one or more inserts 150 is removed from the base 102, the switch is deactivated and the insect attractant(s) are no longer powered. More specifically, the insert 150 may only be fully seated into the base 102 when the insert 150 is facing the proper direction so that the downwardly depending tab 164 is received into a slot 101 in the base 102. Furthermore, the downwardly depending tab 164 can help to ensure the insert 150 is properly inserted into the base 102. The downwardly depending tab 164 can also function as a convenient grip point for the user during insertion or removal of the insert 150. The downwardly depending tab 164 can have any suitable configuration or shape.

The downwardly depending tab 164 may have a maximum width (W_{T}) that is less than 75% of the width of the mounting bracket 120 of the insert 150, or less than 50% the width of the mounting bracket 120 of the insert 150, or less than 25% the width of the mounting bracket 120 of the insert 150, or less than 10% the width of the mounting bracket 120 of the insert 150. The maximum width (W_{T}) of the downwardly depending tab 164 may be from about 5 mm to about 20 mm, or from about 8 mm to about 15 mm, or from about 10 mm to about 13 mm. The length (L_{T}) of the downwardly depending tab 164 may be from about 5 mm to about 40 mm, or from about 10 mm to about 30 mm, or from about 15 mm to about 25 mm. The downwardly depending tab 164 may be substantially planar. The tab 164 may have a first side edge 163 on one side and a second side edge 165 on the other side. Depending on the configuration of the tab 164, the first side edge 163 and the second side edge 165 can converge at a most proximal point 170 of the tab 164. It is to be appreciated that a variety of tab configurations can be utilized without departing from the scope of the present disclosure. For instance, the size, location, and structure of the tab may vary.

The insert 150 may comprise a graspable tab 168. The graspable tab 168 may be positioned on the second end 138 of the insert 150, as shown in FIG. 11. The graspable tab 168 may extend away from the frame 166. The graspable tab 168 may be integral to the frame. The graspable tab 168 may function as a convenient grip point for the user during insertion or removal of the insert 150. The graspable tab 168 may be substantially free of adhesive, to allow the user to grasp the insert 150 without contacting the adhesive 152. The graspable tab 168 may be positioned along the vertical centerline 5-5 of the insert 150 equidistant from the side edges of the frame 166. Alternatively, the graspable tab 168 may not be positioned along the vertical centerline 5-5 of the insert 150 and may be non-equidistant from the side edges of the frame 166. The graspable tab 168 may help to ensure the insert 150 is properly inserted into the housing 123. The shade 122 may have one or more recesses 125 to accommodate the graspable tab 168. The recess 125 may allow the graspable tab 168 to be visible, when a user views the outward-facing surface 126 of the shade 122. The shade 122 may be designed to hide or obscure the insert 150 from view, while the recess 125 allows the graspable tab 168 to be visible. Thus, the graspable tab 168 may indicate to the user where and how to grasp the insert 150. The graspable tab 168 may have any suitable configuration or shape. The dimensions of the graspable tab 168 may be chosen to optimize the grippability of the insert 150, thereby making it easier for a user to grip the insert 150 by the graspable tab 168. The graspable tab 168 may have a surface area of about 50 mm² to about 500 mm², or from about 100 mm² to about 400 mm², or from about 110 mm² to about 300 mm², or from about 120 mm² to about 200 mm², or from about 130 mm² to about 150 mm².

The insert 150 may comprise a reservoir (not shown) for storing an insect attracting composition. The insect attracting composition can be provided in a wide variety of forms, including gases, liquids, solids and combinations thereof. Solid compositions also include semi-solid compositions, such as gels, which comprise one or more liquids and one or more gelling agents. The reservoir may also serve to catch fallen insects, such as the insects that were originally immobilized by the adhesive 152 but are no longer sufficiently retained by the adhesive 152 after drying and becoming brittle. The reservoir may have a volume between about 1 cm³ and 60 cm³. Reservoirs may be made as one piece, which is then attached to the frame. Alternatively, reservoirs, may be integrally formed with the frame from the same material, such as by an injection molding or thermoforming process. The reservoir may be positioned so as not to reduce the surface area of the adhesive 152. Alternatively, the insert 150 may not include a reservoir.

As shown in FIG. 1, at least one LED 114, which serves as arthropod attractant, may be mounted on the base 102 of the device. The type of light source and the peak wavelength of the light emitted from the light source may be selected to attract particular arthropods, as different arthropods may be attracted to different types of light sources and/or different peak wavelengths of light. The light source 114 is preferably a light emitting diode (LED), as shown, which is a form of solid-state lighting. The arthropod trapping device may comprise at least one light source 114, preferably at least one LED, or from about two to about twenty light sources 114, preferably LEDs, or from about two to about ten light source 114s, preferably LEDs.

LEDs may use any suitable attachment technology, such as through-hole technology. One or more LEDs may utilize surface-mount technology (SMT), such that the LEDs are a surface-mount device (SMD). The LEDs may be any shape, preferably the LEDS are conical. Each of the LEDs may have a diameter between about 0.5 mm and about 10 mm. Further, each of the LEDs may have a surface area of 0.5 mm² and about 100 mm². Some examples of LEDs include semi-conductor light emitting diodes, polymer light emitting diodes, and organic light emitting diodes. The trapping device may comprise two or more LEDs, where at least one LED is configured to emit light, directly or indirectly, toward the light-source facing surface 130 of an insert that is inserted in the housing and at least one LED is configured to emit light through a vertical opening 313 in one of the opposing side walls 312, 314.

Other light sources that may be used include, but are not limited to, incandescent or filament-based lights, fluorescent lights, halogen lights, xenon lights or other light sources known in the art. The lights may or may not have a filter to adjust the peak wavelength of their output. Further, as used herein, the light source 114 is the light generating component or element of the lighting technology utilized as the insect attractant. In this regard, the light source 114 may be any of a diode, a filament, an energized gas, and so forth. The light source 114 does not include wiring, connectors, bases, lenses, or elements that may be associated with the light generating component or element.

The arthropod trapping device may comprise at least one LED 114 having a peak wavelength of about 350 nm to about 500 nm, or about 400 nm to about 500 nm, or about 350 nm to about 400 nm. The arthropod trapping device may comprise at least one LED 114 having a peak wavelength of about 350 nm to about 400 nm and at least one LED 114 having a peak wavelength of about 400 nm to about 500 nm. An LED having a peak wavelength of about 400 nm to about 500 nm may emit light toward the insert-facing side 124 of the shade 122 and/or the light source-facing side 130 of the insert 150, for example, in a direction substantially perpendicular to the insert-facing side 124 of the shade 122 and/or the light source-facing side 130 of the insert 150. As shown in FIG. 1, an LED having a peak wavelength of about 350 nm to about 400 nm 114a may be positioned to emit light through a vertical opening 313 in one of the opposing side walls 312, 314 of the shade 122.

Both ultraviolet light (peak wavelength ranging from about 100 nm to about 400 nm) and visible light (peak wavelength ranging from about 400 nm to about 700 nm), especially blue light, are effective at attracting arthropods. High intensity blue light may be optimal for attracting arthropods, but such light may be too bright for use in a user's home. High intensity ultraviolet light may also attract arthropods, but ultraviolet light intensity is preferably moderated for in-home use, as well.

Without being bound by theory, the arthropod trapping device of the present disclosure is designed to effectively balance both blue light intensity and ultraviolet light intensity to increase trapping performance, while providing a trap that is suitable for use in a user's home. It is further believed that emitting light of a selected peak wavelength in a selected direction relative to the shade may optimize trapping performance. For example, as shown in FIG. 1, a LED having a peak wavelength of about 400 nm to about 500 nm 114b may be positioned (on the base 102) to emit light toward the insert-facing side 124 of the shade 122 and/or the light source-facing side 130 of the insert 150 in a direction substantially perpendicular to the shade 122 or insert 150, where some of the light may be reflected off the shade and/or insert. Thus, when an arthropod approaches the trap, the light having a peak wavelength of about 400 nm to about 500 nm 114b is emitted toward the LED-facing surface(s) 130 of the insert(s) 150 and draws the arthropod to the adhesive 152 disposed on the LED-facing surface(s) 130 of the insert 150(s). Also, in use, when the arthropod trapping device is connected to a power source and when two or more inserts are inserted into the housing of the device, each insert may also reflect light onto the opposing insert, which is believed to further draw flying arthropods toward the adhesive surfaces 152 of the inserts 150. It is understood that the LED arrangement shown in FIG. 1 is an example and the number, type, and position of the LEDs may be modified. Also, reflectors and/or lenses may be used to shape the light pattern. Also, the intensity of the light may be adjusted by adjusting the directionality of the light and/or by adjusting the reflectivity of the shade and or insert (thereby adjusting the level of direct illumination versus indirect illumination).

The base 102 may comprise one or more slots 101. The slot(s) 101 may be a narrow, slit opening(s). The slot 101 is sized to allow the downwardly depending tab 164 on the insert 150 to pass therethrough during insertion of the insert 150 into the base 102. In order to provide proper alignment with the tab 164, the slot 101 is horizontally offset from a vertical centerline (not shown) of the base 102. The position of the slot 101 ensures that the first end 136 of the insert 150 may be fully inserted into the base 102 when the insert 150 is properly aligned in the slot 101. As shown in FIG. 20, a plane 400 may divide or bisect the front wall 308 and/or the rear wall 310 of the shade into two horizontal sides. For symmetric shades, the plane 400 may divide or bisect the front wall 308 and/or the rear wall 310 of the shade into two symmetric horizontal halves.

The arthropod trapping device may comprise a shade, a base, and no insert, where adhesive is disposed directly on the shade. As such, the shade may be removably attached to the base, and subsequent to use, the entire shade may be removed and disposed of by the user. A fresh shade may then be affixed to the base and operation of the arthropod trapping device can be resumed. The shade may be otherwise similar to the shade that is configured to receive an insert, as described above.

Arthropod trapping devices in accordance with the present disclosure utilize electricity for operation. As provided above, an example arthropod trapping device can be inserted into a wall outlet so that various onboard attractants can be energized, such as a light source and/or other forms of energizable attractants. Such arthropod trapping devices may also include various liquids, gels, or other compositions that serve to attract insects to the arthropod trapping device. As users will periodically interact with the device, such as to replace a spent insert, providing an insect device that is safe and easy to operate is paramount. For instance, in view of various onboard electric componentry, it is desirable for such electric componentry to be de-energized when a user is interacting with the device, such as when a user is removing a spent insert so that it can be replaced with a fresh insert. It is also desirable for such electric componentry to only be energized when an insert is properly inserted into the base. For instance, providing power to a light source only upon proper insertion of the insert provides beneficial operational feedback to the user. Moreover, causing the de-energization of the onboard electric componentry to occur automatically upon removal of the insert is also desirable to provide for ease of use and safe operation. In providing the above referenced safety benefits, it is also beneficial to provide structural features on the insert and base to ensure the user is inserting the insert into the base in the proper orientation.

In accordance with various arthropod trapping devices described herein, a circuit board is positioned within the base (not shown). Generally, the circuit board receives the power from a power source (e.g., a wall outlet) and distributes the power to the onboard components. The circuit board can be vertically mounted within the base. Vertically positioning the circuit board serves to provide a compact base. Various electrical components may be coupled to the circuit board and extend away from the circuit board. The circuit board, or collection of circuit boards, can include various componentry, such as, without limitation, voltage control circuitry, capacitors, integrated circuits, resistors, and so forth. The circuit board can also include a switch that can control the supply of electricity to the onboard attractants, such as a heating element and a light source. For instance, when the switch is in a first (open) position, some or all of the onboard electrical attractants are de-energized. When the switch is in a second (closed) position, all of the onboard attractants are energized. Due to the vertical arrangement of the circuit board, the switch can be vertically oriented as well. Placement options for large components on the circuit board can be at least partially dictated by the size constraints of the internal cavity of the base and balanced with the desire to provide a compact base. As such, large components can be centrally located on the circuit board, with other lower profile components (such as a switch) horizontally spaced away from the center of the circuit board. In this way, the large components can be positioned as to not interfere with mounting posts, the curvature of base, and so forth, but the overcall form factor of the base can remain generally compact.

The base can include an opening to provide access to the switch that is mounted internal to the base. In order to regulate access to the switch, the opening can be a slot that is positioned vertically above the switch. The slot can be sized to permit an elongated, substantially planar, downwardly depending tab of an insert to pass through the slot and into the cavity of the base, where the tab engages and closes the switch, which may be coupled to the circuit board. The switch may be oriented vertically so that the elongate tab slidingly engages a lever, or other type of actuator, of the switch to close the switch. Closing the switch energizes various components of the base, such as a light source. The base may also include one or more vertical rails (not shown) that are positioned proximate to the switch, such that when the tab is passed through the slot, the rails bias the tab toward the switch. The rails in the base may be configured to bias the tab against the switch, because the tab may otherwise flex outwardly due to its thin and elongate configuration. When fully inserted, the tab can be positioned between the switch and the rails. The rails can be positioned and configured to ensure the tab sufficiently engages the switch, despite its relatively thin profile and flexibility.

However, the narrowly sized slot beneficially restricts the ability of other foreign objects to be passed through the slot. As provided above, the switch can be horizontally spaced away from the center of the circuit board. Accordingly, the slot can be horizontally offset from a vertical centerline of the base as well. The substantially planar tab can be horizontally offset from the vertical centerline of the insert so that it aligns with the slot and switch when the user inserts the insert into the base.

### Methods of Using Arthropod Trapping Device

The arthropod trapping devices described herein may be used to trap or capture arthropods, preferably insects, more preferably flies. The disclosure relates to a method of trapping arthropods in an arthropod trapping device comprising the steps of inserting one or more, preferably two or more, insert(s) having an adhesive disposed thereon into a housing of the arthropod trapping device, where the housing comprises a base having at least one LED mounted on it and a shade coupled to the base, and connecting the arthropod trapping device with a power source, where the arthropod trapping device may comprise a cord and a plug comprising one or more electrically conductive prongs that may be inserted into an electrical power outlet to connect the device to a power source. Alternatively, the device may be powered by a non-rechargeable or rechargeable battery. Alternatively, the device may be turned on by pressing a button on the device. The method may further comprise the step of removing one or more of the inserts from the housing and disposing of the insert, preferably without contacting the adhesive or arthropod remains adhered thereto, whereby removing the one or more inserts from the housing deactivates a switch in the base to de-energize the LED(s).

These steps may be performed in any order. The arthropod trapping device may be used in any room of a home, including a kitchen, a garage, a screened in porch, or a bathroom. The arthropod trapping device may be used in other buildings as well, including commercial buildings and businesses, e.g., free-standing garages, barns, and the like.

In an alternative configuration of the arthropod trapping device, the one or more insert(s) may be planar, and the shade may be substantially cylindrical, with at least one concave insert-facing surface configured to receive the insert(s). The planar insert is preferably flexible. In use, the user may flex, bend, or deflect the planar insert, when inserting it into shade. As discussed above, the shade may include opposing guide rails extending at least partially along the insert-facing surface of the shade. The planar insert may be held in place by the guide rails. Optionally, the insert may at least partially conform to the shape of the shade, for example, the insert may at least partially conform to the concave insert-facing surface of the shade.

In this regard, the disclosure also relates to a method of trapping arthropods in an arthropod trapping device comprising the steps of inserting a planar insert having an adhesive disposed thereon into a housing of the arthropod trapping device, where the housing comprises a base having at least one LED mounted on it and a substantially cylindrical shade coupled to the base, and engaging the base with a power source, where the device may comprise a cord and a plug comprising one or more electrically conductive prongs that may be inserted into an electrical power outlet to connect the device to a power source. Alternatively, the device may be powered by a non-rechargeable or rechargeable battery. Alternatively, the device may be turned on by pressing a button on the device. The step of inserting the planar insert may comprise flexing, bending, or deflecting the planar insert. The planar insert may optionally comprise a downwardly depending tab that is integrally formed with the insert. Alternatively, the planar insert and the tab—the activation tab—may be provided as two separate pieces and the method may further comprise the step of inserting the activation tab into a slot in the base to activate a switch in the base and to energize the LED(s). The method may further comprise the step of removing the insert from the housing and disposing of the insert, preferably without contacting the adhesive or arthropod remains adhered thereto, and removing the activation tab from the base to deactivate the switch in the base and to de-energize the LED(s).

The disclosure also relates to a refill system or refill kit for an arthropod trapping device, the refill system comprising a planar insert having an adhesive disposed thereon and an activation tab, where the planar insert is configured for insertion into a housing of the arthropod trapping device, where the housing comprises a base having at least one LED mounted on it and a shade coupled to the base, and the activation tab is configured for insertion into a slot in the base, where inserting the activation tab into the base activates a switch in the base to energize the LED(s). The device may comprise a cord and a plug comprising one or more electrically conductive prongs that may be inserted into an electrical power outlet. Alternatively, the base may be powered by a non-rechargeable or rechargeable battery.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An arthropod trapping device comprising:
a. a housing comprising a base and a shade coupled to the base, the base and the shade defining an opening in the housing:
i. the base configured to communicate with and receive power from a power source, wherein at least one LED is mounted on the base;
ii. the shade configured to receive more than one insert, wherein the shade comprises a front wall, a rear wall, and first and second side walls located between the front wall and the rear wall, wherein at least one of the side walls, comprises an opening.

2. The arthropod trapping device according to claim 1, wherein the front wall of the shade is configured to receive an insert.

3. The arthropod trapping device according to claim 1, wherein the rear wall of the shade is configured to receive an insert.

4. The arthropod trapping device according to claim 1, wherein the device further comprises a bridge extending over the opening of the housing and joining the inner surfaces of the first and second side walls.

5. The arthropod trapping device of claim 4, wherein the opening in the side wall is a vertical opening and is aligned with the bridge.

6. The arthropod trapping device according to claim 1, wherein the front wall, the rear wall, the first side wall, and the second side wall are continuous and form either a substantially cylindrical shape or a polygonal prism shape.

7. The arthropod trapping device according to claim 1, wherein the shade is substantially symmetrical about a plane that vertically bisects the first and second side walls.

8. The arthropod trapping device according to claim 1, wherein the shade is substantially symmetrical about a plane that vertically bisects the front and rear walls.

9. The arthropod trapping device according to claim 1, wherein the shade comprises one or more guiderails.

10. The arthropod trapping device of claim 9, wherein the shade comprises two pairs of guiderails, a first pair of guiderails disposed on the inner surface of the front wall and a second pair of guiderails disposed on the inner surface of the rear wall.

11. The arthropod trapping device according to claim 1, wherein the device further comprises one or more inserts, each insert comprising a shade-facing surface and a LED-facing surface, wherein an adhesive for trapping the arthropod is disposed on the LED-facing surface, wherein the at least one LED is configured to emit light toward the LED-facing surface of the insert.

12. The arthropod trapping device of claim 11, wherein each insert comprises one or more flanges configured to slide into the one or more guiderails of the shade.

13. The arthropod trapping device of claim 11, wherein each insert comprises a substrate and a frame for supporting the substrate, wherein the LED-facing surface of the substrate has the adhesive disposed thereon.

14. The arthropod trapping device of claim 11, wherein each insert comprises a downwardly depending tab extending from a first end of the frame, wherein the base of the device comprises one or more slots configured to receive the downwardly depending tab.

15. The arthropod trapping device of claim 14, wherein each insert comprises a mounting bracket spaced apart from the LED-facing surface of the insert and located at a first end of the frame, wherein the LED-facing surface of the insert and the bracket define an opening in the insert.

16. The arthropod trapping device of claim 15, wherein the downwardly depending tab extends away from the mounting bracket and wherein the downwardly depending tab activates a switch in the base of the device to energize the LED, when the downwardly depending tab is inserted into the slot.

17. The arthropod trapping device according to claim 1, wherein the shade comprises more than one recess, wherein each recess is configured to receive a graspable tab of an insert.

18. The arthropod trapping device according to claim 1, wherein the base comprises an electrical cord in electrical communication with the at least one LED and wherein the base comprises an annular channel for receiving the electrical cord.

19. The arthropod trapping device according to claim 1, wherein at least one LED has a peak wavelength of from about 400 nm to about 600 nm.

20. The arthropod trapping device according to claim 1, wherein at least one LED has a peak wavelength of from about 350 nm to about 400 nm, emitted through the opening in the side wall.
